(19) United States
(12) Patent Application Publication
(10) Pub. No.: US 2015/0307754 A1
(43) Pub. Date: Oct. 29, 2015

(54) ADHESIVES THAT INCLUDE HIGHLY-PLASTICIZED CELLULOSE ESTERS AND METHODS AND ARTICLES RELATING THERETO

(71) Applicant: Celanese Acetate LLC, Irving, TX (US)

(72) Inventors: Michael Combs, Pembroke, VA (US); Wendy Bisset, Eggleston, VA (US); Lizbeth Milward, Blacksburg, VA (US); Adam Larkin, Dallas, TX (US); Naresh Budhavaram, Florence, KY (US)

(73) Assignee: Celanese Acetate LLC, Irving, TX (US)

(21) Appl. No.: 14/302,550

(22) Filed: Jun. 12, 2014

Related U.S. Application Data
(60) Provisional application No. 61/985,123, filed on Apr. 28, 2014.

(51) Int. Cl. C09J 101/12; C09J 7/04

(52) U.S. Cl. CPC C09J 101/12; C09J 7/045; C09J 2201/606; C09J 2405/00

(57) ABSTRACT

Adhesives may include a base polymer composition, optionally a tackifying resin, optionally a wax, and optionally additives (e.g., plasticizers, fillers, antioxidants, and the like, and combinations thereof), where the base polymer comprises a highly plasticized cellulose ester and optionally polymers traditionally used in pressure sensitive adhesives, hot melt pressure sensitive adhesives, or hot melt adhesives (e.g., ethylene vinyl acetate copolymers, polysiloxanes, and polyurethanes).

### BACKGROUND

The exemplary embodiments described herein relate to adhesive compositions, and methods and articles relating thereto.

Adhesives are useful in several applications from arts and crafts (e.g., hot glue sticks) to consumer products (e.g., cigarette seam line adhesives and repositionable, adhesive paper products like sticky-notes) to packaging (e.g., shipping box and cereal box adhesives).

There are several types of adhesives including pressure sensitive adhesives, pressure sensitive hot melt adhesive, hot melt adhesives, and drying adhesives. As used herein, pressure-sensitive adhesives (“PSA”) refer to adhesive compositions that are tacky at room temperature to the extent that a 4 mil (the unit “mil” refers to a thousandth of an inch) coated paper backing sticks to the adhesive composition with no pressure applied (i.e., with only the weight of the 4 mil coated paper backing). In some instances, PSA may be a viscous paste or putty. As used herein, hot melt pressure-sensitive adhesives (“HMPSA”) refer to adhesive compositions that sticks to a 4 mil coated paper backing at room temperature with weight applied by a roller of 4.5 pounds or less. HMPSA may be tacky or non-tacky at room temperature. As used herein, hot melt adhesives (“HMA”) refers to adhesive compositions that stick to a 4 mil coated paper backing when heated and do not stick to the 4 mil coated paper backing at room temperature with weight applied by a roller of 4.5 pounds or less. As used herein, a “drying adhesive” refers to an adhesive composition that is liquid at room temperature and often includes a solvent that evaporates to increase the adhesive bond between the adhesive and a surface. Drying adhesives may, for example, be in the form of high viscosity pastes or low viscosity fluids (e.g., spray adhesives).

Common PSA, HMPSA, and HMA utilize synthetic polymers (e.g., ethylene vinyl acetate copolymers, polysiloxanes, and polyurethanes) in combination with additives like tackifiers, waxes, and fillers in varying concentrations and compositions for desired PSA, HMPSA, or HMA. However formulated, these adhesives generally may have poor environmental degradability and generally interfere with recycling processes. For example, in removing labels from glass bottles and repulping of paper products, a caustic bath is used to degrade the paper product. Adhesives with synthetic polymers like ethylene vinyl acetate copolymers, polysiloxanes, and polyurethanes generally stay intact when exposed to caustic baths. Therefore, in some instances, additional steps, often costly, labor-intensive steps, are included in such recycling processes to account for the use of these adhesives. Further, in some instances, depending on the amount of adhesive used and local recycling capabilities, the article may be non-recyclable. Accordingly, PSA, HMPSA, and HMA having increased environmental degradability and compatibility with recycling processes may be useful.

### BRIEF DESCRIPTION OF THE DRAWINGS

The following figures are included to illustrate certain aspects of the embodiments presented herein, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-E provide illustrations of nonlimiting examples of article configurations according to at least some embodiments described herein.

FIG. 2 provides intrinsic viscosity as a function of the melt temperature for highly-plasticized cellulose esters according to at least some embodiments described herein.

### DETAILED DESCRIPTION

The exemplary embodiments described herein relate to PSA, HMPSA, and HMA that comprise highly-plasticized cellulose esters (“HPCE”), and methods and articles relating thereto. HPCE described herein may, in some embodiments, include a cellulose ester and a plasticizer, where the plasticizer is at about 15% or greater by weight of the HPCE (e.g., about 15% to about 80% by weight of the HPCE). As used herein, the term “adhesive(s) of the present disclosure,” “adhesive(s) described herein,” or a derivative thereof refers generally to HMA, PSA, and HMPSA collectively. As used herein, the term “plasticizer” refers to a compound that decreases the glass transition temperature (“T_{g}”) of the polymer being plasticized.

The cellulose ester and high concentration of plasticizer in HPCE described herein may be more environmentally degradable (e.g., via both bulk erosion and chemical degradation) than typical synthetic adhesive polymers like ethylene vinyl acetate copolymers, polysiloxanes, and polyurethanes. Further, cellulose is a product of cellulose ester decomposition, which may be considered a natural, environmentally benign composition.

Additionally, caustic baths in recycling processes would decompose the cellulose esters to cellulose, which is the product of caustic bath paper repulping or label removal. Therefore, adhesives that include HPCE would minimally, if at all, impact caustic bath recycling processes.

In some embodiments, the adhesives described herein may include a base polymer composition (which includes HPCE), optionally a tackifying resin, optionally a wax, and optionally additives (e.g., plasticizers, fillers, antioxidants, and the like, and combinations thereof). In some embodiments, the base polymer composition may be included in an adhesive described herein in an amount of about 20% to 100% by weight of the adhesive described herein.

In some embodiments, the base polymer composition may include HPCE at 100% by weight of the base polymer composition. In some embodiments, the base polymer composition may be a blend of HPCE and polymers traditionally used in PSA, HMPSA, or HMA. The inclusion of HPCE in such blends may increase the degradability and recyclability of an adhesive that includes polymers traditionally used in PSA, HMPSA, or HMA (e.g., ethylene vinyl acetate copolymers, polysiloxanes, and polyurethanes).

As used herein, the term “bio-derived” refers to a compound or portion thereof originating from a biological source or produced via a biological reaction. The bio-derived portion of an adhesive described herein refers to the mass percent that is bio-derived.

As used herein, the term “food-grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”).

As used herein, the term “semi-volatile” refers to compounds having a boiling point of about 260° C. to about 400° C.

As used herein, the term “volatile” refers to compounds having a boiling point of about 50° C. to about 260° C.

As used herein, the term “molecular weight” refers to a polystyrene equivalent number average molecular weight (“Mₙ”).

As used herein, the term “water-free” refers to a composition having no more water than is naturally present at standard temperature and pressure with about 100% relative humidity. As used herein, the term “substantially water-free” refers to a composition having no more than about 1% by weight of water above the concentration of water that is naturally present at standard temperature and pressure with 100% relative humidity.

It should be noted that when “about” is used in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

### I. Adhesive Compositions

In some embodiments, the adhesives described herein may include a base polymer composition (which includes HPCE), optionally a tackifying resin, and optionally a wax. In some embodiments, the adhesives described herein may optionally further include additives (e.g., plasticizers, fillers, antioxidants, and the like, and combinations thereof). In some embodiments, the base polymer composition may be included in an adhesive described herein in an amount of about 20% to 100% by weight of the adhesive described herein.

In some embodiments, the base polymer composition may include HPCE at 100% by weight of the base polymer composition. In some embodiments, the base polymer composition of the adhesives described herein may include HPCE at about 1% to about 99% by weight of the base polymer composition and an additional polymer (e.g., ethylene vinyl acetate, polyacrylamides, polyacrylates, styrene block co-polymers, and the like, and combinations thereof) at about 99% to about 1% by weight of the base polymer composition.

HPCE described herein may, in some embodiments, include a cellulose ester and a plasticizer with the plasticizer at about 15% or greater by weight of the HPCE (e.g., about 15% to about 80% by weight of the HPCE). In some embodiments, the plasticizers may be present in the HPCE described herein in an amount ranging from a lower limit of about 15%, 30%, 40%, 50%, or 60% by weight of the HPCE to an upper limit of about 80%, 70%, 60%, or 50% by weight of the HPCE, wherein the amount may range from any lower limit to any upper limit and encompass any subset therebetween (e.g., about 20% to about 40%). In some embodiments, cellulose esters may be present in the HPCE described herein in an amount ranging from a lower limit of about 20%, 30%, 40%, or 50% by weight of the HPCE to an upper limit of about 85%, 70%, 60%, or 50% by weight of the HPCE, wherein the amount may range from any lower limit to any upper limit and encompass any subset therebetween. In some embodiments, the HPCE described herein may consist essentially of cellulose ester and plasticizers. In some embodiments, the HPCE described herein may consist of cellulose ester and plasticizers.

In some embodiments, cellulose esters of the HPCE described herein may have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination.

In some embodiments, cellulose esters of the HPCE described herein may have a degree of substitution of the ester substituent ranging from a lower limit of about 0.5, 1.2, or 2 to an upper limit of less than about 3, about 2.9, 2.7, or 2.5, and wherein the degree of substitution may range from any lower limit to any upper limit and encompass any subset therebetween.

In some embodiments, cellulose esters of the HPCE described herein may have a molecular weight ranging from a lower limit of about 10,000, 15,000, 25,000, 50,000, or 85,000 to an upper limit of about 300,000, 200,000, 150,000, 125,000, 100,000, or 85,000, and wherein the molecular weight may range from any lower limit to any upper limit and encompass any subset therebetween. As used herein, the term “molecular weight” refers to a polystyrene equivalent number average molecular weight (Mₙ).

In some embodiments, cellulose esters of the HPCE described herein may have an intrinsic viscosity ranging from a lower limit of about 0.5 dL/g, 0.7 dL/g, or 1.0 dL/g to an upper limit of about 2.0 dL/g, 1.7 dL/g, 1.5 dL/g, or 1.3 dL/g, and wherein the intrinsic viscosity may range from any lower limit to any upper limit and encompass any subset therebetween. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{rel} ) / k ) - 1 ) where {n}_{rel} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

In some embodiments, cellulose esters described herein may be derived from any suitable cellulosic source. Suitable cellulosic sources may, in some embodiments, include, but are not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), kudzu, and the like, and any combination thereof. Further, it has been surprisingly discovered that the clarity of adhesives described herein does not appear to be substantially impacted by the cellulosic source from which the cellulose esters are derived. This is unexpected because some existing cellulose ester products (that do not have adhesive properties) require high quality, expensive cellulosic sources (e.g., hardwoods with low hemicellulose content) to achieve high clarity.

In some embodiments, the cellulose ester may be recycled from other cellulose ester materials. For example, cellulose acetate tow used in producing, for example, cigarette filters may be used for producing HPCE and the adhesives described herein.

Plasticizers suitable for use in conjunction with the HPCE described herein may, in some embodiments, include, but are not limited to,

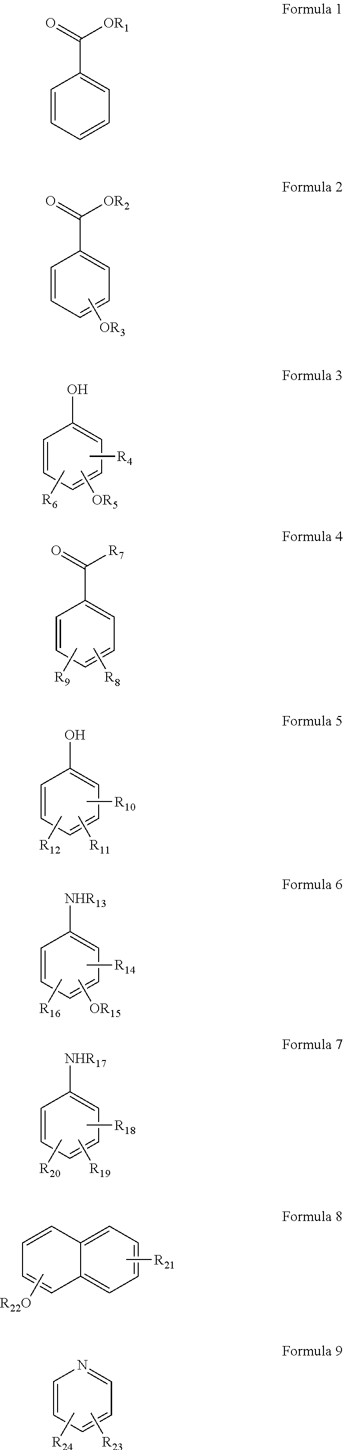

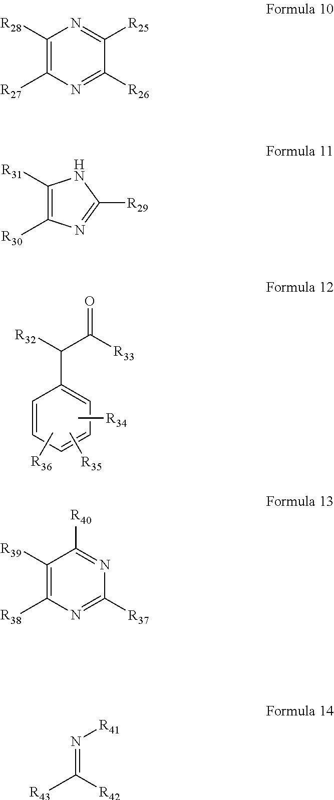

Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazine (1,2,3, 1,2,4, or 1,3,5) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperazine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; R44HN—R45-NHR46 where R44 and R46 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R45 is C₁-C₁₀ alkyl; and combinations thereof. As used herein, “alkyl” refers to a substituent with C and H that may be linear or branched (e.g., t-butyl) and saturated or unsaturated. As used herein, “aryl” refers to an aromatic ring that may include phenyl, naphthyl, and aromatic rings with heteroatoms.

Examples of plasticizers suitable for use in conjunction with the HPCE described herein may, in some embodiments, include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybeonzoate, methyl-4-hydroxybeonzoate, ethyl-4-hydroxybeonzoate, benzyl-4-hydroxybeonzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

Additional examples of plasticizers suitable for use in conjunction with the HPCE described herein may, in some embodiments, be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. It has been discovered that some nonionic surfactants plasticize cellulose esters, alone or in combination with small molecule plasticizers. This is unexpected because traditional plasticizers are small molecules. By contrast, nonionic surfactants are bulky with long hydrocarbon tail groups and potentially large head groups. For example, polyoxyethylene (20) sorbitan monolaurate, which is significantly larger than traditional cellulose ester plasticizers like triacetin, has been observed to plasticize cellulose ester.

In some embodiments, the plasticizers may be food-grade plasticizers, which may be useful in producing adhesives described herein for use in applications where the adhesive may directly or indirectly contact food (e.g., food containers). Examples of food-grade plasticizers may, in some embodiments, include, but are not limited to, triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and the like, and any combination thereof.

In some embodiments, the plasticizers may be bio-derived, which may be useful in producing adhesive compositions that are bio-derived. For example, bio-derived triacetin, diacetin, tripropionin, glyceryl esters, may be produced from glycerol that is a byproduct of biodiesel. Other examples of plasticizers that may be bio-derived may include, but are not limited to, vanillin, acetovanillone, γ-valerolactone, eugenol, epoxidized soybean oil, castor oil, linseed oil, epoxidized linseed oil, and dicarboxylic esters (e.g., dimethyl adipate, dibutyl maleate). In some instances, aroma plasticizers may be extracts from natural products, and therefore, bio-derived plasticizers.

In some embodiments, the plasticizers may be semi-volatile to volatile plasticizers. Examples of some preferred semi-volatile to volatile plasticizers may include, but are not limited to, glycerol esters, (e.g., triacetin, diacetin, monoacetin), ethylene glycol diacetate, alkyl lactones (e.g., γ-valerolactone), dibutyl maleate, di-octyl maleate, dibutyl tartrate, eugenol, tributyl phosphate, tributyl-o-acetyl citrate, and resorcinol monoacetate.

In some instances, two or more plasticizers may be used in HPCE composition. In some instances, it has been surprisingly observed that two or more plasticizers may have synergistic effects. For the same total weight percent of total plasticizer in the HPCE, HPCE with multiple plasticizers may have a greater melt flow index than HPCE with the individual plasticizers alone, which is an unexpected observation.

In some embodiments, the base polymer composition of the adhesives described herein may include additional polymers at about 1% to about 99% by weight of the base polymer composition and an additional polymer at about 99% to about 1% by weight of the base polymer composition. Additional polymers that may be blended with the HPCE to form the base polymer composition may include, but are not limited to, polyolefins, polyalphaolefins, polyesters, ethylene vinyl acetate copolymers, polyvinyl acetate, polyvinyl alcohol (“PVOH”), a polyethyleneimine, polyacrylates, polymethacrylates, polyacrylamides, polyacrylonitriles, polyimides, polyamides, polyvinyl chloride, polysiloxanes, polyurethanes, polystyrene, polyetheramide copolymers, styrene-butadiene copolymers, styrene-butadiene-styrene copolymers, styrene-isoprene-styrene copolymers, styrene-ethylene-butylene-styrene copolymers, styrene-ethylene-propylene-styrene copolymers, butyl rubber, polyisobutylene, isobutylene-isoprene copolymers, acrylics, nitriles, and combinations thereof.

In some instances, the additional polymers blended HPCE to form the base polymer composition may be sufficiently hydrophobic that a compatibilizer is needed to produce a homogeneous blend. Exemplary compatibilizers for use in conjunction with HPCE may be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. Additional exemplary compatibilizers for use in conjunction with HPCE may be polymers that include, but are not limited to, polyethylene glycol less than about 2000 molecular weight. Combinations of the foregoing may also be used. In some embodiments, compatibilizers may be present in the adhesive composition in an amount of about 0.5% to about 20% by weight of the adhesives composition.

Tackifying resins may be useful in increasing the room temperature tack of an adhesive described herein. In some embodiments, a tackifying resin may be present in an adhesive described herein in an amount ranging from a lower limit of 0%, about 1%, 5%, 10%, 20%, or 30% by weight of the adhesive described herein to an upper limit of about 70%, 60%, 50%, 40%, or 30% by weight of the adhesive described herein, and wherein the amount of tackifying resin may range from any lower limit to any upper limit and encompass any subset therebetween.

Examples of tackifying resins suitable for use in conjunction with the adhesives described herein may, in some embodiments, include, but are not limited to, methylcellulose, ethylcellulose, hydroxyethylcellulose, carboxy methylcellulose, carboxy ethylcellulose, amides, diamines, polyesters, polycarbonates, silyl-modified polyamide compounds, polycarbamates, urethanes, natural resins, natural rosins, rosin esters (SYLVATAC® RE85 and SYLVALITE® RE100, both esters of tall oil rosin, available from Arizona Chemical), shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl) acrylamide, methacrylamides, hydroxy alkyl (meth)acrylates, methacrylic acids, acrylic acids, hydroxyethyl acrylates, ethylene vinyl acetate, vinyl acetate ethylene polymers, aliphatic hydrocarbons, cycloaliphatic hydrocarbons (e.g., EASTOTAC® products, available from Eastman Chemical Co.), aromatic hydrocarbons, aromatically modified aliphatic hydrocarbons, cycloaliphatic hydrocarbons, hydrogenated versions of the foregoing hydrocarbons, terpenes, polyterpenes, modified terpenes (e.g., phenolic modified terpene resins like SYLVARES™ TP96 and SYLVARES™ TP2040, available from Arizona Chemical), and the like, any derivative thereof, and any combination thereof.

In some embodiments, tackifiers suitable for use in conjunction with the adhesives described herein may be food-grade tackifiers. Examples of food-grade tackifiers may, in some embodiments, include, but are not limited to, methylcellulose, ethylcellulose, hydroxyethylcellulose, carboxy methylcellulose, carboxy ethylcellulose, natural resins, natural rosins, and the like, and any combination thereof.

In some embodiments, compatibilizers may be used to more homogeneously incorporate tackifying resins into an adhesive described herein. Suitable compatibilizers may include those described above relative to the base polymer composition and may be used at similar concentrations.

In some embodiments, the HPCE in the base polymer composition may provide sufficient tack such that little to no additional tackifying resins (e.g., about 5% or less weight of adhesive described herein) are required in an adhesive described herein.

Waxes may be useful in lowering the melt viscosity, increasing adhesive strength, and increasing temperature resistance of an adhesive described herein. In some embodiments, a wax may be present in an adhesive described herein in an amount ranging from a lower limit of 0%, about 1%, 5%, 10%, or 20% by weight of adhesive described herein to an upper limit of about 40%, 30%, or 20% by weight of adhesive described herein, and wherein the amount of wax may range from any lower limit to any upper limit and encompass any subset therebetween.

Examples of waxes suitable for use in conjunction with the adhesives described herein may, in some embodiments, include, but are not limited to, paraffin waxes (e.g., PACEMAKER® products, available from Citgo Petroleum, OKERIN® products, available from Astor Wax Corporation, PENRECO® products, available from Pennzoil Products Co, R-7152 products, available from Moore & Munger, and PARAFIN WAX 1297, available from International Waxes Ltd.), microcrystalline waxes (e.g., VICTORY® AMBER WAX, available from Petrolite Corp, BARECO® ES-796 Amber Wax, available from Bareco, and OKERIN® 177, available from Astro Wax Corporation), polyethylene waxes (e.g., POLYWAX® products, available from Petrolite, Inc.), polypropylene waxes, by-product polyethylene waxes, Fischer-Tropsch waxes, and the like, and combinations thereof. In some embodiments, waxes may have a melting temperature of about 45° C. to about 125° C.

In some embodiments, compatibilizers may be used to more homogeneously incorporate waxes into an adhesive described herein. Suitable compatibilizers may include those described above relative to the base polymer composition and may be used at similar concentrations.

In some instances, additives may be included in an adhesive described herein. In some embodiments, an additive may be present in an adhesive described herein in an amount ranging from a lower limit of 0%, about 1%, 5%, 10%, or 20% by weight of adhesive described herein to an upper limit of about 40%, 30%, or 20% by weight of adhesive described herein, and wherein the amount of additive may range from any lower limit to any upper limit and encompass any subset therebetween.

Examples of additives suitable for use in conjunction with the adhesives described herein may, in some embodiments, include, but are not limited to, plasticizers that plasticize a component of an adhesive described herein other than the cellulose ester, antioxidants, pigments, adhesion promoters (e.g., silanes and alkyl silanes), viscosity modifiers, lubricants, softening agents, antibacterial agents, antifungal agents, preservatives, flame retardants, corrosion inhibitors, dehydrators, aromas, and the like, and combinations thereof.

Fillers may, in some embodiments, increase the rigidity and decrease the creep of an adhesive described herein, which may consequently increase the mechanical rigidity of an article produced therewith. Examples of fillers may include, but are not limited to, coconut shell flour, walnut shell flour, wood flour, wheat flour, soybean flour, gums, protein materials, calcium carbonate, talc, zeolite, clay, rigid compounds (e.g. lignin), thickeners, unreacted starches, modified starches (e.g., with modifications other than ester modifications like hydroxyethyl starch, hydrolyzed starch, cationic starch, starch phosphate, oxidized starch, and the like), waxy starches, cellulose nanofibrils, nanocrystalline cellulose, glass microspheres, carbonates, talc, silica, silicates, magnesium silicates, and the like, and any combination thereof.

In some embodiments, fillers suitable for use in conjunction with an adhesive described herein may be food-grade fillers. Examples of food-grade fillers may, in some embodiments, include, but are not limited to, coconut shell flour, walnut shell flour, wood flour, wheat flour, soybean flour, gums, starches, protein materials, calcium carbonate, and the like, and any combination thereof.

Flame retardants suitable for use in conjunction with an adhesive described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with an adhesive described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with an adhesive described herein may, in some embodiments, include, but are not limited to, benzoates, parabens (e.g., the propyl-4-hydroxybeonzoate series), and the like, and any combination thereof.

Pigments and dyes suitable for use in conjunction with an adhesive described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with an adhesive described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of an adhesive described herein during storage, transportation, and/or implementation. Antioxidants suitable for use in conjunction with an adhesive described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with an adhesive described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

Viscosity modifiers may, in some embodiments, be advantageous in modifying the melt flow index of an adhesive described herein and/or modify the viscosity of an adhesive described herein. Viscosity modifiers suitable for use in conjunction with an adhesive described herein may, in some embodiments, include, but are not limited to, polyethylene glycols, polypropylene glycols, glycerin, and the like, and any combination thereof, which, in some embodiments, may be a food-grade viscosity modifier.

Aromas suitable for use in conjunction with the adhesives described herein may, in some embodiments, include, but are not limited to, spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vannillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In some instances, a component of an adhesive described herein may perform more than one function in the adhesive described herein. For example, BHT and BHA are both antioxidants and plasticizers for cellulose ester. Additionally, nonionic surfactants may, in some instances, function as both plasticizers and compatibilizers. In another example, aromas like eugenol, cinnamyl alcohol, camphor, methoxy hydroxy acetophenone (acetovanillone), vanillin, and ethylvanillin may also plasticize cellulose ester. In yet another example, benzoates and parabens (e.g., the propyl-4-hydroxybeonzoate series) may be both preservatives and plasticizers for cellulose ester.

In some embodiments, an adhesive described herein may be substantially water-free. As used herein, the term “water-free” refers to a composition having no more water than is naturally present at standard temperature and pressure with 100% relative humidity. As used herein, the term “substantially water-free” refers to a composition having no more than about 1% by weight of water above the concentration of water that is naturally present at standard temperature and pressure with 100% relative humidity.

In some embodiments, the adhesive compositions described herein may be at least in part bio-derived adhesive compositions. In some embodiments, the amount of the adhesive composition that is bio-derived may range from a lower limit of about 2%_{,} 5%, 10%, 25%, 50%, 75%, or 90% to an upper limit of about 100%, 99%, 95%, 90%, 75%, or 50%, and wherein the amount of the adhesive composition that is bio-derived may range from any lower limit to any upper limit and encompasses any subset therebetween.

### II. Adhesive Properties

In some embodiments, the adhesives described herein may be tacky at room temperature. As used herein, the term “tacky” refers to a composition that is tacky at room temperature to the extent that a 4 mil (the unit “mil” refers to a thousandth of an inch) coated paper backing sticks to the adhesive composition with no pressure applied (i.e., with only the weight of the 4 mil coated paper backing). In some instances, tacky compositions may include HPCE where the concentration of plasticized is about 40% or greater by weight of the HPCE.

In some embodiments, the adhesives described herein may be non-tacky at room temperature. In some instances, tacky compositions may include HPCE where the concentration of plasticized is about 60% or less by weight of the HPCE.

The presence or absence of tack in the adhesives described herein at room temperature may be modified by the concentration and composition of plasticizer, the composition of the cellulose esters, the concentration of additional components like tackifiers, waxes, or additional polymers, and the like. Therefore, the foregoing plasticizer concentrations may be viewed as general guidelines and not limiting as to the presence or absence of tack in the adhesives described herein.

The characteristics of the adhesives described herein may be tailored by adjusting the changing the ratios of individual components and changing the physical and chemical properties of individual components (especially the components of the HPCE). Examples of such properties may include, but are not limited to, the composition of the ester substituents of the cellulose esters, the degree of substitution of the ester substituent of the cellulose esters, the molecular weight of the cellulose esters, the composition of the plasticizers in the HPCE, and the like, and any combination thereof. Further, the amount of plasticizer in the HPCE may be tailored to achieve the desired characteristics of the adhesives described herein. Accordingly, the physical and chemical properties of individual components of the adhesive described herein may be changed to achieve PSA, HMPSA, or HMA as desired. This allows for increasing the environmental degradability and recyclability of an adhesive over a variety of applications.

The characteristics of the adhesives described herein that may be tailored to achieve a desired PSA, HMPSA, or HMA may include, but are not limited to, glass transition temperature, melt flow index, melt viscosity, adhesive strength, degradability, clarity, and the like, and any combination thereof.

In some embodiments, an adhesive described herein may have a glass transition temperature of about 190° C. or less. In some embodiments, an adhesive described herein may have a glass transition temperature ranging from a lower limit of not measurable, about −75° C., −70° C., −61° C., −55° C., 10° C., 75° C., 120° C., 130° C., or 150° C. to an upper limit of about 190° C., 175° C., or 150° C., and wherein the glass transition temperature may range from any lower limit to any upper limit and encompass any subset therebetween.

In some embodiments, an adhesive described herein may have no detectible glass transition temperature. As used herein, the term “no detectable glass transition temperature” and derivatives thereof refers to material having no detectable heat flow event (as measured by DSC), which may be caused by the plasticized material having no glass transition temperature or the heat flow broadening to an extent that the glass transition temperature is not detectable.

The glass transition temperature of an adhesive described herein may be measured by differential scanning calorimetry. Factors that affect the glass transition temperature of an adhesive described herein may include, but are not limited to, plasticizer concentration in the HPCE (e.g., a higher concentration of plasticizer may decrease the glass transition temperature), HPCE concentration in the adhesive described herein (e.g., a higher concentration of HPCE may decrease the glass transition temperature), the composition of the cellulose ester and the additional polymer blended with the HPCE, and the like, and combinations thereof.

In some embodiments, an adhesive described herein may have a melt flow index (with a 300 sec melt time) ranging from a lower limit of about 0 g/10 min, 5 g/10 min, 25 g/10 min, 29 g/10 min, 35 g/10 min, or 40 g/10 min (at 150° C./0.5 kg measured in accordance with ASTM D1238) to an upper limit of about 150 g/10 min, 125 g/10 min, 100 g/10 min, 80 g/10 min, 70 g/10 min, 60 g/10 min, 50 g/10 min, or 40 g/10 min (at 150° C./0.5 kg measured in accordance with ASTM D1238), and wherein the melt flow index may range from any lower limit to any upper limit and encompass any subset therebetween. In some instances where the melt flow index at 150° C./500 g is greater than 150 g/10 min, the melt flow index may be measured at 150° C./100 g and range from a lower limit of about 5 g/10 min, 25 g/10 min, 29 g/10 min, 35 g/10 min, or 40 g/10 min (at 150° C./100 g measured in accordance with ASTM D1238) to an upper limit of about 86 g/10 min, 80 g/10 min, 70 g/10 min, 60 g/10 min, 50 g/10 min, or 40 g/10 min (at 150° C./100 g measured in accordance with ASTM D1238), and wherein the melt flow index may range from any lower limit to any upper limit and encompass any subset therebetween. In some embodiments, an adhesive described herein may have a melt flow index that is higher than can be measured at 150° C./100 g (e.g., greater than about 86 g/10 min at 150° C./100 g).

Factors that affect the melt flow index of an adhesive described herein may include, but are not limited to, plasticizer concentration in the HPCE (e.g., a higher concentration of plasticizer may increase the melt flow index), HPCE concentration in the adhesive described herein (e.g., a higher concentration of HPCE may increase the melt flow index), the composition of the cellulose ester and the additional polymer blended with the HPCE, and the like, and combinations thereof.

The melt viscosity of an adhesive described herein may be measure by rheometers (rotational, or capillary).

In some embodiments, an adhesive described herein may have a melt viscosity measure at 150° C. and 100 s⁻¹ ranging from a lower limit of about 500 cP, 1,000 cP, 2,500 cP, or 5,000 cP to an upper limit of 200,000 cP, 150,000 cP, 50,000 cP, 10,000 cP, and wherein the melt viscosity may range from any lower limit to any upper limit and encompass any subset therebetween.

Factors that affect the melt viscosity of an adhesive described herein may include, but are not limited to, plasticizer concentration in the HPCE (e.g., a higher concentration of plasticizer may decrease the melt viscosity), HPCE concentration in the adhesive described herein (e.g., a higher concentration of HPCE may increase the melt viscosity), the composition of the cellulose ester and the additional polymer blended with the HPCE, and the like, and combinations thereof.

The adhesive strength of adhesives described herein may be measured by peel adhesion and/or lap shear strength testing mechanisms.

Peel adhesion can be measured by ASTM 3330/D Method A (Standard test method for peel adhesion of PSA tape (180° Peel)) and tested on a surface of interest (e.g., corrugated cardboard, glass, stainless steel panels). Test method A gives a measure of the adherence, when peeled at 180° angle, to a standard steel panel or to other surfaces of interest (e.g., corrugated board or glass) for a single-coated tape. This test method provides a mean for assessing the uniformity of the adhesion of a given type of adhesive. In this method, a strip is applied to a standard test panel (or other surface of interest) with controlled pressure. The tape is peeled from the panel at 180° angle at a specified rate with a 1 kN load cell, during which the force required to effect peel is measured.

In some embodiments, an adhesive described herein may have a peel adhesion (using with a 4 mil coated paper backing) ranging from a lower limit of about 0.1 lb/in, 0.25 lb/in, 0.5 lb/in, 1 lb/in, 2 lb/in, 3 lb/in, 4 lb/in, or 5 lb/in to an upper limit of about 25 lb/in, 20 lb/in, 15 lb/in, or 10 lb/in, and wherein the peel adhesion may range from any lower limit to any upper limit and encompass any subset therebetween. Depending on the substrate, in some instances, the substrate may fail (e.g., tear) before failure of the adhesive described herein.

In some embodiments, an adhesive described herein may increase in peel adhesion over time when applied to a substrate or surface. A measurement of a change in peel adhesion over time may be analyzed by comparing the 24-hour peel adhesion to the 72-hour peel adhesion. As used herein, the “72-hr percent increase in peel adhesion” is calculated by (peel adhesion at 72 hours−peel adhesion at 24 hours)/(peel adhesion at 24 hours)*100. In some instances, an adhesive described herein may have a 72-hr percent increase in peel adhesion ranging from a lower limit of about 3%, 5%, or 10% to an upper limit of about 300%, 150%, 75%, or 25%, and wherein the percent increase in peel adhesion may range from any lower limit to any upper limit and encompass any subset therebetween.

The lap shear strength of an adhesive described herein can be measured by testing lap shears by tension loading with a 1 kN load cell by a method that includes placing a specimen (two substrates with a 1 inch by 1 inch overlap and 3 mm thick glue line) in the grips of the testing machine so that each end of the specimen is in contact with the grip assemble, applying the loading immediately to the specimen at the rate of 800 lb force of shear per min, and continuing the load to failure of the adhesive or substrate. Adhesives failure is recorded as the lap shear strength, and substrate failure is recorded as substrate failure. In some instances, substrate failure for a 4 mil coated paper has been observed at about 17 kgf. This value may change depending on the substrate and size of the glue line.

In some embodiments, an adhesive described herein may have a lap shear strength (using with a 4 mil coated paper backing) ranging from a lower limit of about 0.2 kgf, 0.5 kgf, 1 kgf, 2 kgf, 4 kgf, or 6 kgf to an upper limit of about 17 kgf, 15 kgf, 10 kgf, 8 kgf, 6 kgf, or 4 kgf, and wherein the lap shear strength may range from any lower limit to any upper limit and encompass any subset therebetween. In some instances, the 4 mil coated paper may fail before the adhesive described herein fails. In some embodiments, an adhesive described herein may have a lap shear strength (using an aluminum or stainless steel substrate) ranging from a lower limit of about 0.2 kgf, 0.5 kgf, 1 kgf, 2 kgf, 5 kgf, or 10 kgf to an upper limit of about 50 kgf, 30 kgf, 20 kgf, 15 kgf, or 10 kgf, and wherein the lap shear strength may range from any lower limit to any upper limit and encompass any subset therebetween.

Factors that affect the adhesive strength of an adhesive described herein may include, but are not limited to, plasticizer concentration in the HPCE (e.g., a higher concentration of plasticizer may decrease the lap shear strength but may increase tack and peel adhesion), HPCE concentration in the adhesive described herein (e.g., a higher concentration of HPCE may lap shear strength), the composition of the cellulose ester and the additional polymer blended with the HPCE, the environmental conditions (e.g., temperature), and the like, and combinations thereof.

As used herein, the term “degradation” includes both mechanical and chemical degradation. In some embodiments, an adhesive described herein may degrade to a greater extent for a given time frame than a comparable adhesive composition where the HPCE is replaced with a cellulose diacetate material plasticized with 20% triacetin. In some embodiments, an adhesive described herein may degrade by about 5% or greater by weight than a cellulose diacetate material plasticized with 20% triacetin in a procedure performed according to EN13432 “Requirements for Packaging Recoverable through Composting and Biodegradation—Test Scheme and Evaluation Criteria for the Final Acceptance of Packaging.” In some embodiments, an adhesive described herein may degrade by an amount ranging from a lower limit of about 5%, 10%, or 15% to an upper limit of about 300%, 200%, 100%, 50%, 40%, or 30% by weight than a comparable adhesive composition where the HPCE is replaced with a cellulose diacetate material plasticized with 20% triacetin in a procedure performed according to EN13432 “Requirements for Packaging Recoverable through Composting and Biodegradation—Test Scheme and Evaluation Criteria for the Final Acceptance of Packaging,” and wherein the degradation may range from any lower limit to any upper limit and encompass any subset therebetween.

Factors that affect the degradability of an adhesive described herein may include, but are not limited to, plasticizer concentration in the HPCE (e.g., a higher concentration of plasticizer may increase the degradability), HPCE concentration in the adhesive described herein (e.g., a higher concentration of HPCE may increase the degradability), the composition of the cellulose ester and the additional polymer blended with the HPCE, and the like, and combinations thereof.

The haze (a measure of clarity) of an adhesive described herein can be measured with properly sized specimens substantially plane-parallel surfaces (e.g., flat without wrinkling) free of dust, scratches, and particles of about 0.85 mm in thickness using an UtraScan Pro from Hunter Lab with D65 Illuminant/10° observer. In some embodiments, an adhesive described herein may have a haze ranging from a lower limit of about 3, 5, 15, 20, or 25 to an upper limit of about 100 (i.e., intentionally opaque), 85, 70, 60, or 40, and wherein the haze may range from any lower limit to any upper limit and encompass any subset therebetween. In some instances, the haze value may be significantly larger than the preferred ranges above (e.g., about 100) when additives like titanium dioxide are used in significant quantities to produce an opaque adhesive. Additionally, pigments and dyes may affect the haze of the adhesive.

Factors that affect the clarity of an adhesive described herein may include, but are not limited to, HPCE concentration in the adhesive described herein (e.g., a higher concentration of HPCE may decrease the clarity and increase the haze), the composition of the cellulose ester and the additional polymer blended with the HPCE, and the like, and combinations thereof.

### III. Methods of Producing Adhesives Described Herein

Producing adhesives described herein may, in some embodiments, involve blending the components of the adhesive described herein (e.g., the HPCE, the optional additional polymer, the optional tackifying resins, the optional waxes, and the optional additives). In some instances, blending may involve high-shear mixing processes. In some instances, blending may be performed at an elevated temperature (e.g., a temperature above room temperature). In some instances, the components of the adhesive may be heated before and during blending. Some embodiments may involve a combination of the foregoing.

In some embodiments, additives may be incorporated into an adhesive described herein the mixing step. In some embodiments, additives may be incorporated into an adhesive described herein after the mixing step by, for example, via absorption. Absorption may, in some embodiments, be advantageous for the incorporation of volatile additives and/or small molecule additives (e.g., some fragrances, aromas, dyes, and pigments).

In some instances, the HPCE may be produced before combining the HPCE with the other components of the adhesive described herein. Producing an adhesive described herein may involve at least one of mixing, compounding, high-shear mixing, heating, or preheating the cellulose ester and/or the plasticizer.

In some instance, the HPCE may be mixed, compounded, etc. with a compatibilizer before adding the additional polymer to the adhesive described herein.

Some embodiments may involve using an adhesive described herein immediately after production/mixing for an application (e.g., applying the adhesive described herein to a substrate so as to form a laminate surface on the substrate).

In some embodiments, a portion of an adhesive described herein may be produced, formed into pellets, pillows, or other forms and coated with the remaining components of the adhesive. For example, HPCE may be produced and coated with or encased by an additional polymer such that when the produced coated HPCE is melted and mixed, the desired adhesive described herein is produced.

Additional embodiments may involve forming an adhesive described herein into a desired form. Depending on its characteristics, an adhesive described herein may be in the form of a paste, a putty, pellets, or a molded shape (e.g., a glue stick or an adhesive sheet). It should be noted that the term “sheet” should not be interpreted to be limited in thickness, width or length, and encompasses films, layers, and the like. Forming an adhesive described herein into a desired form may, in some embodiments, be a consequence of production of the adhesive (e.g., a paste or a putty). In some embodiments, forming an adhesive described herein into a desired form may involve methods like extruding, injection molding, blow molding, over molding, compression molding, casting, calendaring, near net shape molding, melt casting, and the like, any hybrid thereof, and any combination thereof.

In some embodiments, an adhesive described herein in sheet form may have a thickness ranging from a lower limit of about 15 microns, 20 microns, 30 microns, 50 microns, or 100 microns to an upper limit of about 1200 microns, 800 microns, 400 microns, 200 microns, or 100 microns, and wherein the thickness may range from any lower limit to any upper limit and encompasses any subset therebetween. While these thicknesses may be preferred, one skilled in the art, with the benefit of this disclosure, should understand that the thicknesses described are not limiting to the structure of a sheet described herein and thicknesses outside these ranges may be achieved.

In some embodiments, an adhesive described herein in laminate form on a substrate may be produced by applying an adhesive melt to the substrate (e.g., via melt casting); and allowing the adhesive melt to cool, thereby yielding the laminate on the substrate. In some embodiments, the laminate may be smooth and substantially non-tacky at room temperature. In some embodiments, the laminate may be tacky at room temperature (e.g., for self-adhesive articles) and may optionally have a second substrate applied to the laminate (e.g., to protect the adhesive laminate or to layer the self-adhesive articles).

In some embodiments, a laminate may have a thickness ranging from a lower limit of about 15 microns, 20 microns, 30 microns, 50 microns, or 100 microns to an upper limit of about 500 microns, 400 microns, 300 microns, 200 microns, or 100 microns, and wherein the thickness may range from any lower limit to any upper limit and encompasses any subset therebetween. While these thicknesses may be preferred, one skilled in the art, with the benefit of this disclosure, should understand that the thicknesses described are not limiting to the structure of a laminate described herein and thicknesses outside these ranges may be achieved.

In some instances, a higher concentration of HPCE in an adhesive described herein may increase the flow of the adhesive melt at lower temperatures, which may produce laminates with more uniform thickness and allow for thinner laminates that tend to be more flexible. More uniform thicknesses may provide for higher quality articles and, in some instances, higher clarity laminates.

Some embodiments may further involve treating the laminate to reduce the concentration of plasticizer in the laminate. Treating may involve drying, heating, applying vacuum, and the like, and any combination thereof. Reducing the concentration of the plasticizer may increase the stiffness and chemical resistance of the laminate.

Some embodiments may further involve treating the laminate to change surface chemistry of the laminate. For example, a caustic bath may be utilized to produce a laminate with a superhydrophilic surface.

### IV. Articles Comprising Adhesives Described Herein and Methods Relating Thereto

Some embodiments may involve applying an adhesive described herein to a surface. In some instances, the adhesive described herein may be exposed to the local environment and not necessarily adhering two or more surfaces together. For example, an iron-on design or heat-activated window tint may be have an adhesive disposed on one side that may later be heated to adhere to a second surface.

Some embodiments may involve adhering a first surface to a second surface with an adhesive described herein. In some embodiments, at least one of the surfaces may be releasable from the adhesive (e.g., an envelope with an adhesive between the paper and a release strip, a roll of tape where the adhesive preferably adheres to one side of the tape, or a stack of self-adhesive notes or paper where each note is individually removable from the stack and capable of being adhered to other surfaces, or a toilet paper or paper towel roll where the outermost sheet is adhered to the roll). In some embodiments, the first surface and the second surface may correspond to a first substrate and a second substrate, respectively. In some embodiments, the first surface and the second surface may correspond to the same substrate (e.g., a single piece of paper rolled into a cylinder and adhered to itself along a seam line). In some embodiments, articles described herein may be extended to three or more surfaces, including hundreds or thousands of surfaces (e.g., adhesive book bindings), without departing from the spirit of this disclosure.

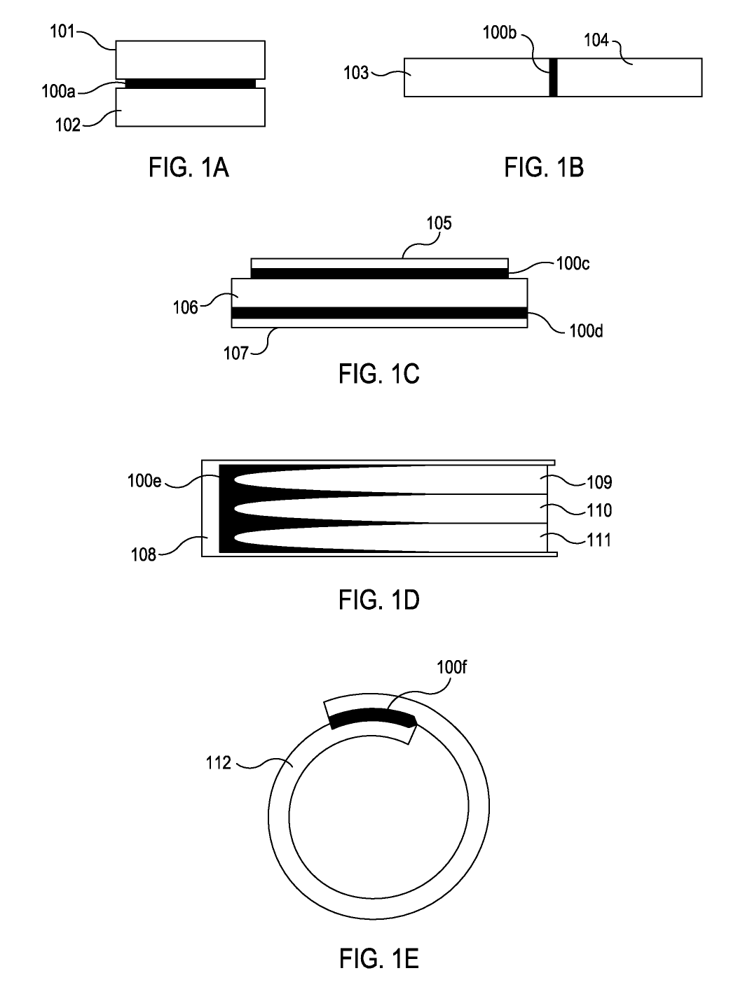

In some embodiments, the articles described herein may be designed with the first surface and the second surface adhered in any suitable configuration. Examples of suitable configurations may, in some embodiments, include, but are not limited to, those illustrated in FIG. 1. FIG. 1A illustrates a first substrate 101 and a second substrate 102 adhered together with an adhesive described herein 100a in a stacked configuration. FIG. 1B illustrates a first substrate 103 and a second substrate 104 adhered together an adhesive described herein 100b in a side-by-side configuration. FIG. 1C illustrates a first substrate 105, a second substrate 106, and a third substrate 107 adhered together with an adhesive described herein 100c, 100d in a stacked configuration where each substrate 105,106,107 has different sizes. FIG. 1D illustrates a plurality of substrates in a hybrid configuration, wherein substrates 109,110,111 are each embedded at one end in an adhesive described herein 100e which further adheres substrates 109,110,111 to substrate 108. FIG. 1E illustrates a substrate 112 rolled and adhered to itself at a seam with an adhesive described herein 100f. One skilled in the art with the benefit of this disclosure should recognize that FIGS. 1A-1E are merely examples of possible configurations of articles described herein and that a multitude of other configurations are possible and within the bounds of this disclosure.

Exemplary examples of articles or applications that may utilize an adhesive described herein may, in some embodiments, include, but are not limited to, smoking articles (e.g., cigarettes), envelopes, larger mailing envelopes, tape, cardboard packaging (e.g., mailing packages and food containers like cereal boxes and frozen dinner containers), books, notebooks, magazines, sticky-notes, corrugated boxes, decorative boxes, paper bags, grocery bags, folding cartons, cardboard rolls (e.g., for toilet paper or paper towels), seam lines on toilet paper and paper towels that prevent unrolling, wrapping paper, wallpaper, paper honeycomb, emery boards, electric insulation paper, air filters, papier-mâché articles, carpets, dartboards, furniture or components thereof (e.g., carpet and/or fabric coated headboards, chairs, stools, edge banding, and laminated wood), picture frames, medical garments (e.g., disposable gowns and surgical masks), bandages, therapeutic patches, feminine hygiene products, diapers, shoes, clothing (e.g., binding), glues for labels (e.g., self-adhesive labels and HM or HMPSA glues for labels (e.g., replacing casein glues)), self-adhesive stamps, self-adhesive window covering films (e.g., protective films for glass or other substrates), self-adhesive window coverings (e.g., decorative window stickers, window films, and window tinting), heat activated films, light films, light filters, iron-on designs, substrates with laminated surfaces (e.g., laminated paper, laminated business cards, a laminated paper board, or a protective covering directly laminated onto a surface like glass), a coated substrate, automobiles or components thereof (e.g., temperature or sound insulation adhesively secured in place), electronics (e.g., for insulation or containment), and the like. In some instances, adhesives described herein may have adhesive strength at lower temperatures, which may be related to the glass transition temperature, and allow for applications or uses in cold environments like sealing frozen-food packaging, aerospace applications, low temperature electronics, and the like.

Substrates or surfaces suitable for use in conjunction with articles described herein may, in some embodiments, include, but are not limited to, fibers, woven fiber substrates, nonwoven fiber substrates, foamed substrates, solid substrates, and the like, any hybrid thereof, and any combination thereof.

Substrates or surfaces suitable for use in conjunction with articles described herein may, in some embodiments, comprise materials that include, but are not limited to, ceramics, natural polymers, synthetic polymers, metals, natural materials, carbons, and the like, and any combination thereof. Examples of ceramics may, in some embodiments, include, but are not limited to, glass, quartz, silica, alumina, zirconia, carbide ceramics, boride ceramics, nitride ceramics, and the like, and any combination thereof. Examples of natural polymers may, in some embodiments, include, but are not limited to, cellulose, starch, polylactic acid, polyhydroxyalkonates, polyhydroxybutyrates, and the like, any derivative thereof, and any combination thereof. Examples of synthetic polymers may, in some embodiments, include, but are not limited to, cellulose diacetate, cellulose triacetate, synthetic bamboo, rayon, acrylic, aramid, nylon, polyolefins, polyethylene, polypropylene (including biaxially oriented polypropylene substrates), polyethylene terephthalate, polyesters, polyamides, zylon, polyolefin copolymers (e.g., ethylene vinyl acetate), polysulfides, polyethers (including liquid crystalline polymer, polyoxomethylene), and the like, any derivative thereof, and any combination thereof. Examples of metals may, in some embodiments, include, but are not limited to, steel, stainless steel, aluminum, copper, and the like, any alloy thereof, and any combination thereof. Examples of natural materials may, in some embodiments, include, but are not limited to, wood, grass, animal hide, and the like, and any combination thereof. Examples of carbons may, in some embodiments, include, but are not limited to, carbon fibers, and the like, any derivative thereof, and any combination thereof.

Exemplary examples of substrates suitable for use in conjunction with the articles described herein may, in some embodiments, include, but are not limited to, paper, cardboard, card stock, sand paper, bond paper, wallpaper, wrapping paper, cotton paper, tipping paper, bleached paper, colored paper, construction paper, sisal paper, coated paper, wax paper, CLARIFOIL® (cellulose diacetate film, available from Celanese Corporation), woven fabrics, continuous filament nonwoven fabrics, carded nonwoven fabrics, tow, fiber bundles, twill, twine, rope, carpet, carpet backing, leather, animal hide, insulation, wood and/or grass derived substrates (e.g., wood veneers, particle board, fiberboard, medium-density fiberboard, high-density fiberboard, oriented strand board, cork, hardwoods (e.g., balsa wood, beech, ash, birch, Brazil wood, cherry, chestnut, elm, hickory, mahogany, maple, oak, rosewood, teak, walnut, locust, mango, alder, and the like), softwoods (e.g., pine, fir, spruce, cedar, hemlock, and the like), rough lumber, finished lumber, natural fibrous material, and bamboo), foam substrates (e.g., memory foams, polymer foams, polystyrene foam, polyurethane foam, frothed polyurethane, and soy-based foams), and the like, and any combination thereof.

By way of nonlimiting example, an article (e.g., a cigarette paper or a paper towel roll) may comprise two surfaces of a single substrate (e.g., a tipping paper or a cardboard) adhered together (e.g., at a seam line) with an adhesive described herein.

By way of another nonlimiting example, an article (e.g., a cardboard container for shipping or containing food) may comprise two surfaces adhered together with an adhesive described herein.

By way of yet another nonlimiting example, an article (e.g., a food container) may comprise two surfaces (e.g., a cardboard container and a cellulose diacetate film (like CLARIFOIL®)) adhered together with an adhesive described herein.

By way of another nonlimiting example, an article (e.g., window tints or window coverings) may comprise a first surface (e.g., a polyester film) with an adhesive described herein disposed thereon so as to allow for adherence to a second surface (e.g., a glass surface or other similar transparent surface). In some embodiments, the article may comprise, in order, the first surface, the adhesive described herein, and a peelable layer that can be removed before adherence to the second surface. In some embodiments, the article may comprise an adhesive described herein that is smooth and substantially non-tacky at room temperature such that a peelable layer is not required and the adhesive may be exposed to air. In such embodiments, heat may be utilized in adhering the first surface to the second surface.

By way of yet another nonlimiting example, an article (e.g., an iron-on design, heat activated film, or laminated card) may comprise a surface or substrate (e.g., paper, a fabric, or a polymer film) with an adhesive described herein disposed thereon. In some instances, the article may then be adhered to another surface (e.g., applying heat so as to adhere an iron-on design or heat activated film to another surface like a piece of clothing or other fabric). In some embodiments, the article may be formed by applying an adhesive melt to the surface or substrate and allowing the adhesive melt to cool so as to form a laminate on the surface or substrate.

By way of nonlimiting example, an article (e.g. a labelled bottle) may comprise a first surface (e.g., a plastic or glass container) to which an adhesive described herein may be applied for use in adhering a second surface (e.g., a paper label, a plastic label, or a CLARIFOIL® label) to the first surface. In some instances, the adhesive described herein may be on the second surface before application to the first surface. The adhesive described herein may have unique advantages in relation to recycling of the bottles. For example, the components of at least some of the adhesive described herein, especially the HPCE portion of the adhesive, may be compatible with the current plastic recycling technologies (which allows for a 100% recyclable bottle) and glass bottle washing technologies (which allows for labels to be removed in a caustic bath without additional steps and cost).

Some embodiments described herein may involve adhering two or more surfaces together using an adhesive described herein. In some embodiments, adhering may involve heating the adhesive described herein and/or applying pressure to the adhesive described herein.

In some embodiments, adhering surfaces together may involve heating an adhesive described herein to yield an adhesive melt; applying the adhesive melt to a first surface; and adhering a second surface to the first surface with the adhesive.

In some embodiments wherein an adhesive described herein is tacky, adhering surfaces together may involve applying an adhesive described herein to a first surface; and adhering a second surface to the first surface with the adhesive disposed thereon.

In some embodiments, adhering surfaces together may involve disposing an adhesive sheet between a first surface and a second surface; and heating the adhesive sheet so as to adhere the first surface and the second surface together.

Embodiments disclosed herein may include: an adhesive comprising (1) a base polymer composition (e.g., at about 20% to about 100% by weight of the adhesive) that includes HPCE (a cellulose ester and a plasticizers at 15% or greater by weight of the HPCE) and an additional polymer at a weight ratio of about 1:99 to about 100:0, (2) optionally a tackifying resin (e.g., at 0% to about 70% by weight of the adhesive), (3) optionally a wax (e.g., at 0% to about 40% by weight of the adhesive), and (4) optionally an additive (e.g., at 0% to about 40% by weight of the adhesive). Embodiments disclosed herein may also include: mixing the components of one of the foregoing adhesive to produce the adhesive. Embodiments disclosed herein may also include: applying at least one of one of the foregoing adhesives to a surface. Embodiments disclosed herein may also include: adhering two or more surfaces together with at least one of one of the foregoing adhesives. Embodiments disclosed herein may also include: an article that includes at least one substrate with at least one of the foregoing adhesives disposed on at least a portion of a surface of the substrate.

Embodiments Disclosed Herein Include:

A. an adhesive that includes a base polymer composition that includes a highly plasticized cellulose ester and an additional polymer, the highly plasticized cellulose ester at about 1% to about 99% by weight of the base polymer, the additional polymer at about 1% to about 99% by weight of the base polymer, the highly plasticized cellulose ester comprising a cellulose ester and a plasticizer at about 15% or greater by weight of the highly plasticized cellulose ester, and the additional polymer being selected from the group consisting of a polyolefin, a polyalphaolefin, a polyester, an ethylene vinyl acetate copolymer, a polyvinyl acetate, a polyvinyl alcohol, a polyethyleneimine, a polyacrylate, a polymethacrylate, a polyacrylamide, a polyacrylonitrile, a polyimide, a polyamide, polyvinyl chloride, a polysiloxane, a polyurethane, polystyrene, a polyetheramide copolymer, a styrene-butadiene copolymer, a styrene-butadiene-styrene copolymer, a styrene-isoprene-styrene copolymer, a styrene-ethylene-butylene-styrene copolymer, a styrene-ethylene-propylene-styrene copolymer, butyl rubber, polyisobutylene, a isobutylene-isoprene copolymer, an acrylic, a nitrile, and a combination thereof;

B. a method that includes blending a highly plasticized cellulose ester and an additional polymer the highly plasticized cellulose ester at about 1% to about 99% by weight of the blend, the additional polymer at about 1% to about 99% by weight of the blend, the highly plasticized cellulose ester comprising a cellulose ester and a plasticizer at about 15% or greater by weight of the highly plasticized cellulose ester, and the additional polymer being selected from the group consisting of a polyolefin, a polyalphaolefin, a polyester, an ethylene vinyl acetate copolymer, a polyvinyl acetate, a polyvinyl alcohol, a polyethyleneimine, a polyacrylate, a polymethacrylate, a polyacrylamide, a polyacrylonitrile, a polyimide, a polyamide, polyvinyl chloride, a polysiloxane, a polyurethane, polystyrene, a polyetheramide copolymer, a styrene-butadiene copolymer, a styrene-butadiene-styrene copolymer, a styrene-isoprene-styrene copolymer, a styrene-ethylene-butylene-styrene copolymer, a styrene-ethylene-propylene-styrene copolymer, butyl rubber, polyisobutylene, a isobutylene-isoprene copolymer, an acrylic, a nitrile, and a combination thereof;

C. a method that includes applying an adhesive of Embodiment A to a surface of a substrate; and

D. an article that includes an adhesive of Embodiment A disposed on a surface of a substrate.

Each of embodiments A, B, C, and D may have one or more of the following additional elements in any combination: Element 1: the adhesive further including a tackifying resin; Element 2: Element 1 wherein the tackifying resin is present in an amount of at about 1% to about 70% by weight of the adhesive; Element 3: the adhesive further including about 5% or less of a tackifying resin by weight of the adhesive; Element 4: the adhesive further including a wax; Element 5: Element 4 wherein the wax is present in an amount of at about 1% to about 40% by weight of the adhesive; Element 6: the adhesive further including an additive; Element 7: Element 6 wherein the additive is present in an amount of at about 1% to about 40% by weight of the adhesive; Element 8: the adhesive further including a tackifying resin in an amount of at about 1% to about 70% by weight of the adhesive; a wax is present in an amount of at about 1% to about 40% by weight of the adhesive; and an additive is present in an amount of at about 1% to about 40% by weight of the adhesive; Element 9: wherein the plasticizer comprises a nonionic surfactant; Element 10: wherein the highly plasticized cellulose ester includes the plasticizer at about 40% to about 80% by weight of the highly plasticized cellulose ester; Element 11: wherein the plasticizer comprises at least one plasticizer described herein; Element 12: wherein the plasticizer comprises a mixture of two or more plasticizers; Element 13: wherein the adhesive is a pressure sensitive adhesive; Element 14: wherein the adhesive is a hot melt pressure sensitive adhesive; Element 15: wherein the adhesive is a hot melt adhesive; Element 16: wherein the base polymer consists essentially of the highly plasticized cellulose ester and the additional polymer; and Element 17: wherein the base polymer consists of the highly plasticized cellulose ester and the additional polymer. By way of non-limiting example, exemplary combinations applicable to A, B, C, D include: Element 3 in combination with Element 13 and optionally Element 12, Element 9, or both; Element 3 in combination with Element 14 and optionally Element 12, Element 9, or both; Element 8 in combination with Element 13 and optionally Element 12, Element 9, or both; Element 8 in combination with Element 14 and optionally Element 12, Element 9, or both; Element 8 in combination with Element 15 and optionally Element 12, Element 9, or both; and Element 16 or Element 17 in combination with Element 10, Element 12, or a combination thereof and one of Elements 13-15.

Embodiments Disclosed Herein Include:

E. an adhesive that includes a base polymer composition that consists essentially of a highly plasticized cellulose ester comprising a cellulose ester and a plasticizer at about 15% or greater by weight of the highly plasticized cellulose ester; and at least one selected from the group consisting of a tackifying resin, a wax, and any combination thereof;

F. a method that includes blending a highly plasticized cellulose ester and at least one selected from the group consisting of a tackifying resin, a wax, and any combination thereof;

G. a method that includes applying an adhesive of Embodiment E to a surface of a substrate; and

H. an article that includes an adhesive of Embodiment E disposed on a surface of a substrate.

Each of embodiments E, F, G, and H may have one or more of the following additional elements in any combination: Element 18: the adhesive further including a tackifying resin; Element 19: Element 18 wherein the tackifying resin is present in an amount of at about 1% to about 70% by weight of the adhesive; Element 20: the adhesive further including about 5% or less of a tackifying resin by weight of the adhesive; Element 21: the adhesive further including a wax; Element 22: Element 21 wherein the wax is present in an amount of at about 1% to about 40% by weight of the adhesive; Element 23: the adhesive further including an additive; Element 24: Element 23 wherein the additive is present in an amount of at about 1% to about 40% by weight of the adhesive; Element 25: the adhesive further including a tackifying resin in an amount of at about 1% to about 70% by weight of the adhesive; a wax is present in an amount of at about 1% to about 40% by weight of the adhesive; and an additive is present in an amount of at about 1% to about 40% by weight of the adhesive; Element 26: wherein the plasticizer comprises a nonionic surfactant; Element 27: wherein the highly plasticized cellulose ester includes the plasticizer at about 40% to about 80% by weight of the highly plasticized cellulose ester; Element 28: wherein the plasticizer comprises at least one plasticizer described herein; Element 29: wherein the plasticizer comprises a mixture of two or more plasticizers; Element 30: wherein the adhesive is a pressure sensitive adhesive; Element 31: wherein the adhesive is a hot melt pressure sensitive adhesive; Element 32: wherein the adhesive is a hot melt adhesive; and Element 33: wherein the base polymer consists of the highly plasticized cellulose ester. By way of non-limiting example, exemplary combinations applicable to E, F, G, H include: Element 20 in combination with Element 30 and optionally Element 29, Element 26, or both; Element 20 in combination with Element 31 and optionally Element 29, Element 26, or both; Element 25 in combination with Element 30 and optionally Element 29, Element 26, or both; Element 25 in combination with Element 31 and optionally Element 29, Element 26, or both; Element 25 in combination with Element 32 and optionally Element 29, Element 26, or both; and Element 33 in combination with Element 27, Element 29, or a combination thereof and one of Elements 30-32.

To facilitate a better understanding of the embodiments described herein, the following examples of preferred or representative embodiments are given. In no way should the following examples be read to limit, or to define, the scope of the disclosure.

### EXAMPLES

### Example 1

A plurality of adhesive samples was prepared by compounding cellulose acetate and a plasticizer in the amounts and compositions detailed in Table 1. The cellulose acetates tested were CA-1 having a degree of substitution of about 2.5 and a molecular weight (Mₙ) of about 78,000, CA-2 having a degree of substitution of about 2.4 and a Mₙ of about 44,000, and CA-3 having a degree of substitution of about 2.4 and a Mₙ of about 62,000. The characteristics of the adhesive samples and control cellulose acetate samples without plasticizer were measured and are reported in Table 2.

TABLE 1

| | Cellulose Acetate | Plasticizer | |
|---|---|---|---|
| Sample | Composition | Composition | Wt % Plasticizer |
| CA-1 | CA-1 | | 0 |
| HPCE-1 | CA-1 | triacetin | 20 |
| HPCE-2 | CA-1 | triacetin | 40 |
| HPCE-3 | CA-1 | triacetin | 60 |
| HPCE-4 | CA-1 | tributyl phosphate | 20 |
| HPCE-5 | CA-1 | tributyl phosphate | 40 |
| HPCE-6 | CA-1 | tributyl phosphate | 60 |
| CA-2 | CA-2 | | 0 |
| HPCE-7 | CA-2 | triacetin | 60 |
| HPCE-8 | CA-2 | triacetin | 70 |
| HPCE-9 | CA-2 | tributyl phosphate | 60 |
| CA-3 | CA-3 | | 0 |
| HPCE-10 | CA-3 | triacetin | 60 |
| HPCE-11 | CA-2 | eugenol | 50 |
| HPCE-12 | CA-2 | ethylvanillin | 50 |
| HPCE-13 | CA-2 | triacetin and | 62 (92:8 |
| | | ethylvanillin | triacetin:ethylvanillin) |
| HPCE-14 | CA-2 | triacetin and | 64 (84:16) |
| | | ethylvanillin | |
| HPCE-15 | CA-2 | acetovanillone | 50 |
| HPCE-16 | CA-2 | triacetin and | 62 (92:8) |
| | | acetovanillone | |

TABLE 2

| | | | | Complex |
|---|---|---|---|---|
| | | | | Viscosity³ |
| Sample | Description | MP¹ (° C.) | T_{g}² (° C.) | (Pa * s) |
| CA-1 | white flake | | 167-207⁴ | |
| HPCE-1 | clear; stiff; brittle | | 80 | 93,777 |
| HPCE-2 | clear; flexible; tacky | | −55 | 7,187 |
| HPCE-3 | clear; flexible; | 150¹ | −53 | 2,417 |
| | stretchy; very tacky | | | |
| HPCE-4 | clear; stiff; brittle | 166² | none | 122,456 |
| | | | detected | |
| HPCE-5 | clear; stiff with | 180² | 14 | 56,004 |
| | some flexibility | | | |
| HPCE-6 | clear; flexible; tacky | 180¹ | 12 | 13,661 |
| CA-2 | white flake | | 167-207⁴ | |
| HPCE-7 | clear; flexible; | | −44 | 4,037 |
| | stretchy; tacky | | | |
| HPCE-8 | gel-like | | −61 | 4,037 |
| HPCE-9 | clear; flexible | | 15 | 23,230 |
| CA-3 | white flake | | 167-207⁴ | |
| HPCE-10 | clear; flexible; | | −57 | |
| | stretchy; tacky | | | |
| HPCE-11 | clear; coloured; | | −43 | |
| | tacky; flexible | | | |
| HPCE-12 | hard; glass-like; | | −35 | |
| | clear-yellow | | | |
| HPCE-13 | clear; flexible | | −53 | |
| HPCE-14 | clear; flexible | | −51 | |
| HPCE-15 | hard; glass-like; | | −34 | |
| | clear yellow | | | |
| HPCE-16 | clear; flexible | | −52 | |

¹Flow onset point as measured by visual inspection upon heating.
²Glass transition temperature as measured by TA Instruments DSC Q2000.
³Complex viscosity at 140° C. by TA Instruments Rheometer Discovery HR-2.
⁴Literature values for cellulose acetate.

### Example 2

Samples HPCE-3, HPCE-6, HPCE-7, and HPCE-9 were tested for adherence between a glass surface and a cardboard surface. A portion of the sample was added to a glass slide and heated to between 60° C. and 100° C. Then a piece of cardboard was applied to the adhesive, which was then allowed to cool. The cardboard piece was then peeled from the glass slide.

Adhesion was achieved in all samples. Upon trying to separate the two substrates, the cardboard pieces adhered with samples HPCE-3, HPCE-6, and HPCE-7 were unable to be peeled without rupturing the cardboard. The cardboard piece adhered with sample HPCE-9 was able to be cleanly peeled from the glass slide.

### Example 3

HPCE-7 was tested for thermal stability by storing in a freezer for over 24 hours two paper surfaces glued together. Once warmed to room temperature, the paper surfaces were manually pulled and remained adhered together. Further, the seam where the HPCE-7 adhered to the two paper surfaces remained flexible after the temperature cycling. This example appears to demonstrate, to at least some extent, the temperature stability of at least some of the adhesive described herein.

### Example 4

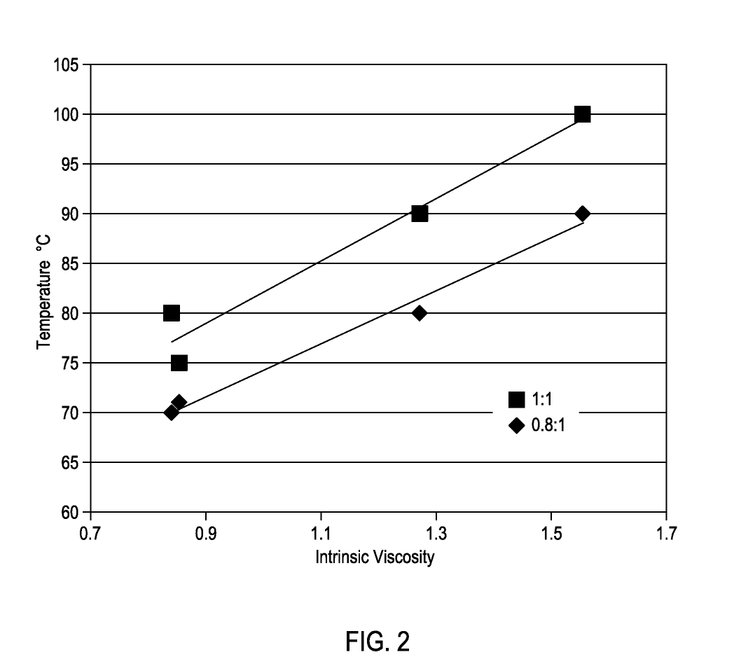

Mixes of CA with intrinsic viscosities from 0.8 to 1.6 and triacetin content to CA ratio of 1:1 and 0.8:1 were prepared. The mixes were analyzed for the changes in melt temperature as a function of intrinsic viscosity. As shown in FIG. 2, a substantially linear relationship was observed where increased intrinsic viscosity yields a linear increase in melt temperature. Further, a higher plasticizer concentration yields a lower melt temperature at the same intrinsic viscosity. This example appears to demonstrate the ability to tailor the flow onset temperature response by controlling intrinsic viscosity or plasticizer concentration of HPCE.

### Example 5

An adhesive melt was prepared by compounding cellulose diacetate (40% by weight of the adhesive melt) with triacetin plasticizer (60% by weight of the adhesive melt) and placing the compounded mixture in an oven for about 5 min at 140° C. The adhesive melt was then coated to one surface/side of a card-stock paper substrate and allowed to cool so as to yield a laminate film on the paper surface. The coated substrate was subjected to an additional heating step at 140° C. for 2-3 minutes. The laminate film was glossy, flexible, and well adhered to the surface precluding the need for both film and laminating adhesive.

### Example 6

A plurality of adhesive samples were prepared by compounding cellulose acetate and a plasticizer in the amounts and compositions detailed in Table 3. The cellulose acetates tested were CA-2 from Example 1 and CA-4 having a degree of substitution of about 2.4, a Mₙ of about 60,000, and an intrinsic viscosity of about 1.36 dL/g. The characteristics of the adhesive samples and control cellulose acetate samples without plasticizer were measured and are reported in Table 4.

TABLE 3

| | Cellulose | | |
|---|---|---|---|
| | Acetate | | |
| | Compo- | | |
| Sample | sition | Plasticizer Composition | Wt % Plasticizer |
| HPCE-17 | CA-4 | diacetin | 60 |
| HPCE-18 | CA-4 | triacetin | 60 |
| HPCE-19 | CA-1 | diacetin | 60 |
| HPCE-20 | CA-4 | diacetin and | 62 (92:8 |
| | | acetylsalicylic acid | diacetin:acetylsalicylic |
| | | | acid) |
| HPCE-21 | CA-4 | triacetin and | 62 (92:8) |
| | | acetylsalicylic acid | |
| HPCE-22 | CA-4 | triacetin and butylated | 62 (92:8) |
| | | hydroxytoluene | |
| HPCE-23 | CA-4 | diacetin and butylated | 62 (92:8) |
| | | hydroxytoluene | |
| HPCE-24 | CA-4 | triacetin and butylated | 62 (92:8) |
| | | hydroxyanisol | |
| HPCE-25 | CA-4 | diacetin and butylated | 62 (92:8) |
| | | hydroxyanisol | |
| HPCE-26 | CA-4 | triacetin and benzoic | 62 (92:8) |
| | | acid | |
| HPCE-27 | CA-4 | diacetin and benzoic | 62 (92:8) |
| | | acid | |
| HPCE-28 | CA-4 | triacetin and | 62 (92:8) |
| | | SYLVATAC ® RE85 | |
| HPCE-29 | CA-4 | diacetin and | 62 (92:8) |
| | | SYLVATAC ® RE85 | |
| HPCE-30 | CA-4 | triacetin and | 62 (92:8) |
| | | SYLVALITE ® RE100 | |
| HPCE-31 | CA-4 | diacetin and | 62 (92:8) |
| | | SYLVALITE ® RE100 | |
| HPCE-32 | CA-2 | triacetin and | 62 (92:8) |
| | | SYLVATAC ® RE85 | |
| HPCE-33 | CA-2 | triacetin and | 62 (92:8) |
| | | SYLVALITE ® RE100 | |
| HPCE-34 | CA-4 | diacetin and ethyl | 62 (92:8) |
| | | vanillin | |
| HPCE-35 | CA-2 | triacetin and ethyl | 62 (92:8) |
| | | vanillin | |
| HPCE-36 | CA-4 | diacetin and salicylic | 62 (92:8) |
| | | acid | |
| HPCE-37 | CA-4 | triacetin and xylitol | 62 (92:8) |
| HPCE-38 | CA-4 | triacetin and sorbitol | 62 (92:8) |
| HPCE-39 | CA-2 | triacetin and xylitol | 62 (92:8) |
| HPCE-40 | CA-2 | triacetin and sorbitol | 62 (92:8) |
| HPCE-41 | CA-2 | triacetin and gamma | 62 (92:8) |
| | | valerolactone | |

TABLE 4

| | | | Melt Flow Index⁶ |
|---|---|---|---|
| Sample | Description | T_{g}⁵ (° C.) | (g/10 min) |
| CA-4 | white flake | 167-207⁷ | |
| HPCE-17 | clear; flexible; stretchy | −69 | 40 |
| HPCE-18 | clear; flexible; stretchy | −53 | 31 |
| HPCE-19 | clear; hard | −66 | 16 |
| HPCE-20 | clear; flexible; | −66 | 57 |
| | stretchy; tacky | | |
| HPCE-21 | clear; flexible; | −54 | 49 |
| | stretchy; tacky | | |
| HPCE-22 | clear-yellow; flexible; | −55 | |
| | stretchy | | |
| HPCE-23 | clear-yellow; flexible; | −63 | 56 |
| | stretchy | | |
| HPCE-24 | clear-yellow; flexible; | −55 | |
| | stretchy; tacky | | |
| HPCE-25 | clear-yellow; flexible; | −62 | 46 |
| | stretchy; tacky | | |
| HPCE-26 | clear-yellow; flexible; | −56 | 51 |
| | stretchy; tacky | | |
| HPCE-27 | clear-yellow; flexible; | −59 | 67 |
| | stretchy; tacky | | |
| HPCE-28 | yellow; flexible | −54 | 45 |
| HPCE-29 | yellow; flexible | −61 | 38 |
| HPCE-30 | white; flexible; | −54 | 68 |
| | stretchy; tacky | | |
| HPCE-31 | white; flexible; | | 47 |
| | stretchy; tacky | | |
| HPCE-32 | white; flexible; | −53 | 27⁸ |
| | stretchy; tacky | | |
| HPCE-33 | white; flexible; | −53 | 21⁸ |
| | stretchy; tacky | | |
| HPCE-34 | clear-yellow; flexible; | −68 | 81 |
| | stretchy; tacky | | |
| HPCE-35 | clear; flexible; | −54 | 34⁸ |
| | stretchy; tacky | | |
| HPCE-36 | clear-yellow; flexible; | −63 | 80 |
| | stretchy; tacky | | |
| HPCE-37 | clear; flexible | −51 | 44 |
| HPCE-38 | clear; flexible | −56 | 41 |
| HPCE-39 | clear; flexible | −55 | |
| HPCE-40 | clear; flexible | −54 | |

⁵Glass transition temprature as measured by TA Instruments DSC Q2000.
⁶Melt flow index measured at 150° C. with a 500 g weight.
⁷Literature values for cellulose acetate.
⁸Melt flow index measured at 150° C. with a 100 g weight.

### Example 7

Some of the adhesive compositions from Tables 1 and 3 were tested for peel adhesion by ASTM 3330/D Method A (180° Peel) after a 24 hour dwell time conditioned at 22° C. and 60% relative humidity. The adhesive strength was measured on stainless steel, glass, and corrugated cardboard and is presented in Table 5.

TABLE 5

| | | | | 180° Peel |
|---|---|---|---|---|
| | | 180° Peel | 180° Peel | Corrugated |
| | Adhesive | Stainless Steel | Glass | Cardboard |
| | Thickness | Substrate 24 hr. | Substrate 24 hr. | Substrate 24 hr. |
| | (mil) | Dwell Time | Dwell Time | Dwell Time |
| Sample | (mil) | Mean (lbf/in) | Mean (lbf/in) | Mean (lbf/in) |
| HPCE-14 | 1.5 | 3.0 | 2.6 | 1.7 |
| HPCE-16 | 5 | 1.7 | 2.4 | 1.4 |
| HPCE-41 | 1.5 | 0.8 | 1.7 | 1.7 |

### Example 8

A plurality of adhesive samples were prepared by compounding cellulose acetate (CA-4 of Example 6) and a plasticizer in the amounts and compositions detailed in Table 6. The characteristics of the adhesive samples were measured and are reported in Table 6.

TABLE 6

| | | | Melt Flow Index⁶ |
|---|---|---|---|
| Sample | Plasticizer | T_{g}⁵ (° C.) | (g/10 min) |
| HPCE-17 | 60 wt % diacetin | −69 | 40 |
| HPCE-42 | 62 wt % diacetin | −68 | 82 |
| HPCE-20 | 57 wt % diacetin and | −66 | 57 |
| | 5 wt % acetylsalicylic acid | | |
| HPCE-43 | 50 wt % acetylsalicylic acid | −21 | less than 1 |
| HPCE-44 | 60 wt % acetylsalicylic acid | −32 | less than 1 |
| HPCE-45 | 33 wt % diacetin and | −57 | 125 |
| | 33 wt % acetylsalicylic acid | | |
| HPCE-46 | 49.5 wt % diacetin and | −59 | 100 |
| | 16.5 wt % acetylsalicylic acid | | |
| HPCE-47 | 16.5 wt % diacetin and | −48 | 100 |
| | 49.5 wt % acetylsalicylic acid | | |

⁵Glass transition temprature as measured by TA Instruments DSC Q2000.
⁶Melt flow index measured at 150° C. with a 500 g weight.

### Example 9

This example appears to demonstrate the synergistic effect on melt flow index using multiple plasticizers in the adhesives described herein. A plurality of adhesive samples were prepared by compounding cellulose acetate (CA-4 of Example 6) and a plasticizer in the amounts and compositions detailed in Table 7. The characteristics of the adhesive samples were measured and are reported in Table 7.

TABLE 7

| | | | Melt Flow Index⁶ |
|---|---|---|---|
| Sample | Plasticizer | T_{g}⁵ (° C.) | (g/10 min) |
| HPCE-17 | 60 wt % diacetin | −69 | 40 |
| HPCE-48 | 60 wt % triethylcitrate | −56 | 15 |
| HPCE-49 | 30 wt % diacetin and | −61 | 45 |
| | 30 wt % triethylcitrate | | |
| HPCE-42 | 62 wt % diacetin | −68 | 82 |
| HPCE-79 | 62 wt % imidazole | −50 | less than 1 |
| HPCE-51 | 57 wt % diacetin and | −62 | 109 |
| | 5 wt % imidazole | | |

⁵Glass transition temprature as measured by TA Instruments DSC Q2000.
⁶Melt flow index measured at 150° C. with a 500 g weight.

### Example 10

This example appears to demonstrate the use of amines as plasticizers in the adhesives described herein. A plurality of adhesive samples were prepared by compounding cellulose acetate (CA-4 of Example 6) and a plasticizer in the amounts and compositions detailed in Table 8. The characteristics of the adhesive samples were measured and are reported in Table 8.

TABLE 8

| Sample | Plasticizer | T_{g}⁵ (° C.) |
|---|---|---|
| HPCE-17 | 60 wt % diacetin | −69 |
| HPCE-50 | 60 wt % imidazole | −53 |
| HPCE-51 | 57 wt % diacetin and | −62 |
| | 5 wt % imidazole | |
| HPCE-52 | 50 wt % ethylene diamine | none |
| | | detected |
| HPCE-53 | 50 wt % piperidine | none |
| | | detected |
| HPCE-54 | 50 wt % piperazine | −60 |
| HPCE-55 | 50 wt % hexanediamine | −65 |

⁵Glass transition temprature as measured by TA Instruments DSC Q2000.

### Example 11

This example appears to demonstrate the effect of tackifiers on the properties of the adhesives described herein. A plurality of adhesive samples were prepared by compounding cellulose acetate (CA-4 of Example 6 or CA-5 (a blend of two cellulose acetates both having a degree of substitution of about 2.3 and each an intrinsic viscosity of about 1.27 dL/g and 1.21 dL/g), a plasticizer, and tackifiers (terpene phenolic resins, SYLVARES™ TP96 and SYLVARES™ TP2040 and rosin esters, SYLVALITE™ RE 100XL, available from Arizona Chemical) in the amounts and compositions detailed in Table 9. The characteristics of the adhesive samples were measured and are reported in Table 9.

TABLE 9

| | | | | | Melt Flow |
|---|---|---|---|---|---|
| | | | | | Index |
| Sample | Cellulose | Plasticizer | Tackifier | T_{g}⁵ (° C.) | (g/10 min) |
| HPCE-56 | CA-4 | 57 wt % | 5 wt % | −68 | 51⁶ |
| | | diacetin | SYLVARES ™ | | |
| | | | TP96 | | |
| HPCE-57 | CA-4 | 57 wt % | 5 wt % | −68 | 62⁶ |
| | | diacetin | SYLVARES ™ | | |
| | | | TP2040 | | |
| HPCE-58 | CA-5 | 51 wt % | 15 wt % | −66 | 49⁸ |
| | | diacetin | SYLVARES ™ | | |
| | | | TP2040 | | |
| HPCE-59 | CA-5 | 57 wt % | 5 wt % | none | 10⁸ |
| | | diacetin | SYLVALITE ™ | detected | |
| | | | RE 100XL | | |
| HPCE-60 | CA-5 | 51 wt % | 15 wt % | −62 | 11⁸ |
| | | diacetin | SYLVALITE ™ | | |
| | | | RE 100XL | | |
| HPCE-61 | CA-5 | 47.12 wt % | 14.88 wt % | −62 | 5⁸ |
| | | diacetin | SYLVALITE ™ | | |
| | | | RE 100XL | | |
| HPCE-62 | CA-5 | 42 wt % | 30 wt % | −61 | 30⁸ |
| | | diacetin | SYLVALITE ™ | | |
| | | | RE 100XL | | |
| HPCE-63 | CA-5 | 32.24 wt % | 29.76 wt % | −61 | 32⁶ |
| | | diacetin | SYLVALITE ™ | | |
| | | | RE 100XL | | |

⁵Glass transition temprature as measured by TA Instruments DSC Q2000.
⁶Melt flow index measured at 150° C. with a 500 g weight.
⁸Melt flow index measured at 150° C. with a 100 g weight.

### Example 12

This example appears to demonstrate the effect of nonionic surfactants on the properties of the adhesives described herein. A plurality of adhesive samples were prepared by compounding cellulose acetate (CA-5 of Example 11), a plasticizer, tackifiers, and surfactant (GLYCOMUL® L, sorbitan monolaurate, available from Lonza) in the amounts and compositions detailed in Table 10. The characteristics of the adhesive samples were measured and are reported in Table 10.

TABLE 10

| | | | | | | MFI⁸ |
|---|---|---|---|---|---|---|
| Sample | Cellulose | Plasticizer | Tackifier | Surfactant | T_{g}⁵ (° C.) | (g/10 min) |
| HPCE- | CA-5 | 57 wt % | 5 wt % | 0 wt % | none | 10 |
| 59 | | diacetin | SYLVALITE ™ | | detected | |
| | | | RE 100XL | | | |
| HPCE- | CA-5 | 43.89 wt % | 18.8 wt % | 5 wt % | −65 | 48 |
| 64 | | diacetin | SYLVALITE ™ | | | |
| | | | RE 100XL | | | |

⁵Glass transition temprature as measured by TA Instruments DSC Q2000.
⁸Melt flow index measured at 150° C. with a 100 g weight.

### Example 13

This example appears to demonstrate the effect of cellulosic source on the properties of the adhesives described herein. A plurality of adhesive samples were prepared by compounding cellulose acetate from different cellulosic sources. CA-4 and CA-5 described in Examples 6 and 11, respectively, were prepared with acetate grade cellulose, which has an alpha-cellulose content of greater than 94%. CA-6 was prepared to have similar degree of substitution and molecular weight as CA-4 but with viscose grade cellulose starting material, which has an alpha-cellulose content of about 90% to about 94%. The adhesive formulations and characteristics are provided in Table 11.

TABLE 11

| | | | | | MFI |
|---|---|---|---|---|---|
| Sample | Cellulose | Plasticizer | Tackifier | T_{g}⁵ (° C.) | (g/10 min) |
| HPCE-17 | CA-4 | 60 wt % | 0% | −69 | 40⁶ |
| | | diacetin | | | |
| HPCE-42 | CA-4 | 62 wt % | 0% | −68 | 82⁶ |
| | | diacetin | | | |
| HPCE-65 | CA-6 | 60 wt % | 0% | −67 | 75⁶ |
| | | diacetin | | | |
| HPCE-66 | CA-6 | 62 wt % | 0% | −66 | 101⁶ |
| | | diacetin | | | |
| HPCE-59 | CA-5 | 57 wt % | 5 wt % | none | 10⁸ |
| | | diacetin | SYLVALITE ™ RE | detected | |
| | | | 100XL | | |
| HPCE-60 | CA-5 | 51 wt % | 15 wt % | −62 | 11⁸ |
| | | diacetin | SYLVALITE ™ RE | | |
| | | | 100XL | | |
| HPCE-61 | CA-5 | 47.12 wt % | 14.88 wt % | −62 | 5⁸ |
| | | diacetin | SYLVALITE ™ RE | | |
| | | | 100XL | | |
| HPCE-67 | CA-6 | 57 wt % | 5 wt % | −72 | 44⁸ |
| | | diacetin | SYLVALITE ™ RE | | |
| | | | 100XL | | |
| HPCE-68 | CA-6 | 51 wt % | 15 wt % | −55 | 37⁸ |
| | | diacetin | SYLVALITE ™ RE | | |
| | | | 100XL | | |
| HPCE-69 | CA-6 | 47.12 wt % | 14.88 wt % | −66 | 27⁸ |
| | | diacetin | SYLVALITE ™ RE | | |
| | | | 100XL | | |

⁵Glass transition temprature as measured by TA Instruments DSC Q2000.
⁶Melt flow index measured at 150° C. with a 500 g weight.
⁸Melt flow index measured at 150° C. with a 100 g weight.

### Example 14

This example appears to demonstrate the effect of nonionic surfactants on the properties of the adhesives described herein. A plurality of adhesive samples were prepared by compounding cellulose acetate (CA-5 of Example 11), a plasticizer, tackifiers, and surfactant in the amounts and compositions detailed in Table 12. The characteristics of the adhesive samples were measured and are reported in Table 12.

TABLE 12

| | | | | T_{g}⁵ | MFI⁸ |
|---|---|---|---|---|---|
| Sample | Plasticizer | Tackifier | Surfactant | (° C.) | (g/10 min) |
| HPCE-70 | 37.62 wt % | 25 wt % | 5 wt % | −63 | 31 |
| | diacetin | SYLVALITE ™ | BRIJ L23 | | |
| | | RE 100XL | (30% (w/v) in | | |
| | | | H₂O | | |
| HPCE-71 | 37.62 wt % | 25 wt % | 5 wt % | −64 | 41 |
| | diacetin | SYLVALITE ™ | SIDERCEL SF | | |
| | | RE 100XL | 140 | | |
| HPCE-72 | 37.62 wt % | 25 wt % | 5 wt % | −62 | 31 |
| | diacetin | SYLVALITE ™ | TRITON X-100 | | |
| | | RE 100XL | | | |
| HPCE-73 | 37.62 wt % | 25 wt % | 5 wt % | −63 | 17 |
| | diacetin | SYLVALITE ™ | POLYFOX PF- | | |
| | | RE 100XL | 151N | | |
| HPCE-74 | 37.62 wt % | 25 wt % | 5 wt % | −64 | 41 |
| | diacetin | SYLVALITE ™ | GLYCOSPERSE | | |
| | | RE 100XL | L-20 KFG | | |
| HPCE-75 | 39.60 wt % | 26.4 wt % | 0 wt % | −66 | 11 |
| | diacetin | SYLVALITE ™ | | | |
| | | RE 100XL | | | |

⁵Glass transition temprature as measured by TA Instruments DSC Q2000.
⁸Melt flow index measured at 150° C. with a 100 g weight.

### Example 15

This example appears to demonstrate the ability to produce adhesives with base polymers that include HPCE and traditional adhesive polymers (e.g., ethylene vinyl acetate copolymer (“EVA”) and polyvinyl alcohol (“PVOH”)). Interestingly, in these exemplary adhesive compositions, compatibilizers were not required. A plurality of adhesive samples were prepared by compounding cellulose acetate (CA-5 of Example 11), a plasticizer, and an additional polymer in the amounts and compositions detailed in Table 13. The characteristics of the adhesive samples were measured and are reported in Table 13.

TABLE 13

| | | | Additional | T_{g}⁵ | MFI⁸ |
|---|---|---|---|---|---|
| Sample | Cellulose | Plasticizer | Polymer | (° C.) | (g/10 min) |
| HPCE-76 | 38% CA-5 | 57% | 5% EVA | −62 | 61 |
| | | diacetin | (28% vinyl | | |
| | | | acetate) | | |
| HPCE-77 | 38% CA-5 | 57% | 5% PVOH | −65 | 40 |
| | | diacetin | (98.4% | | |
| | | | hydrolysis) | | |
| HPCE-78 | 38% CA-5 | 57% | 5% PVOH | −63 | 34 |
| | | diacetin | (88% | | |
| | | | hydrolysis) | | |

⁵Glass transition temprature as measured by TA Instruments DSC Q2000.
⁸Melt flow index measured at 150° C. with a 100 g weight.

Therefore, this disclosure is well adapted to attain the ends and advantages mentioned as well as those that are inherent therein. The particular embodiments disclosed above are illustrative only, as the embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. An adhesive comprising:
a base polymer composition that includes a highly plasticized cellulose ester and an additional polymer, the highly plasticized cellulose ester at about 1% to about 99% by weight of the base polymer, the additional polymer at about 1% to about 99% by weight of the base polymer, the highly plasticized cellulose ester comprising a cellulose ester and a plasticizer at about 15% or greater by weight of the highly plasticized cellulose ester, and the additional polymer being selected from the group consisting of a polyolefin, a polyalphaolefin, a polyester, an ethylene vinyl acetate copolymer, a polyvinyl acetate, a polyvinyl alcohol, a polyethyleneimine, a polyacrylate, a polymethacrylate, a polyacrylamide, a polyacrylonitrile, a polyimide, a polyamide, polyvinyl chloride, a polysiloxane, a polyurethane, polystyrene, a polyetheramide copolymer, a styrene-butadiene copolymer, a styrene-butadiene-styrene copolymer, a styrene-isoprene-styrene copolymer, a styrene-ethylene-butylene-styrene copolymer, a styrene-ethylene-propylene-styrene copolymer, butyl rubber, polyisobutylene, a isobutylene-isoprene copolymer, an acrylic, a nitrile, and a combination thereof.

2. The adhesive of claim 1 further comprising:
a tackifying resin.

3. The adhesive of claim 2, wherein the tackifying resin is present in an amount of at about 1% to about 70% by weight of the adhesive.

4. The adhesive of claim 1 further comprising:
about 5% or less of a tackifying resin by weight of the adhesive.

5. The adhesive of claim 1 further comprising:
a wax.

6. The adhesive of claim 5, wherein the wax is present in an amount of at about 1% to about 40% by weight of the adhesive.

7. The adhesive of claim 1 further comprising:
an additive.

8. The adhesive of claim 7, wherein the additive is present in an amount of at about 1% to about 40% by weight of the adhesive.

9. The adhesive of claim 1 further comprising:
a tackifying resin in an amount of at about 1% to about 70% by weight of the adhesive;
a wax is present in an amount of at about 1% to about 40% by weight of the adhesive; and
an additive is present in an amount of at about 1% to about 40% by weight of the adhesive.

10. The adhesive of claim 1, wherein the plasticizer comprises at least one selected from the group consisting of: Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazine (1,2,3, 1,2,4, or 1,3,5) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperazine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; R44HN—R45-NHR46 where R44 and R46 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R45 is C₁-C₁₀ alkyl; and combinations thereof

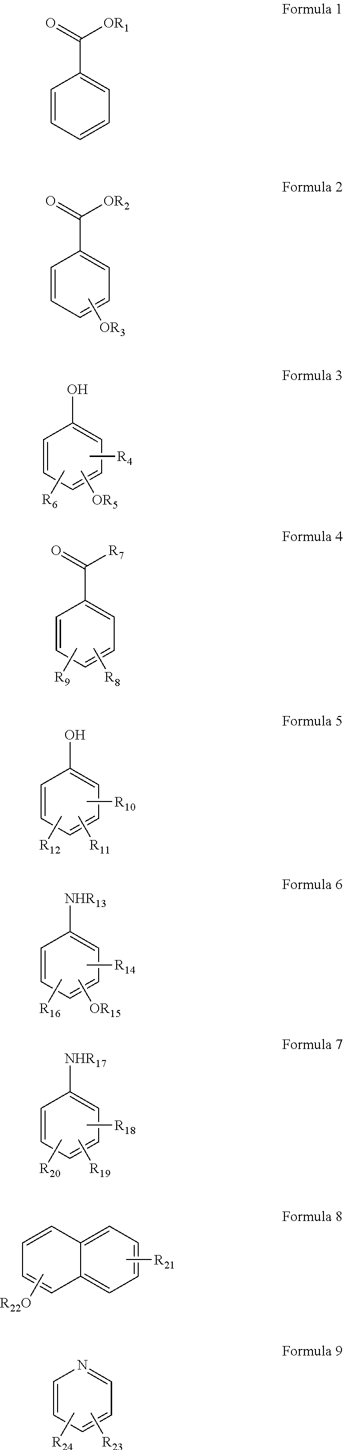

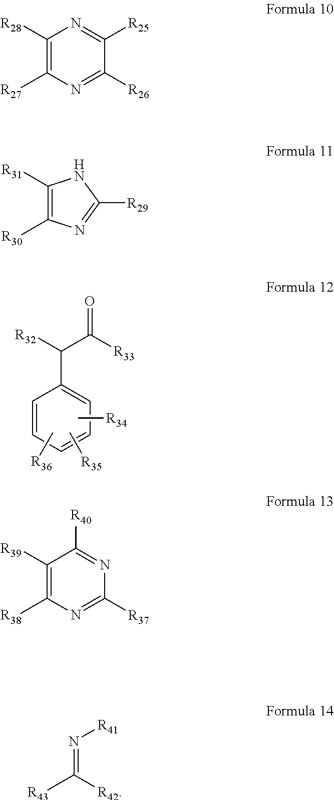

11. The adhesive of claim 1, wherein the plasticizer comprises at least one selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybeonzoate, methyl-4-hydroxybeonzoate, ethyl-4-hydroxybeonzoate, benzyl-4-hydroxybeonzoate, butylated hydroxytoluene, butylated hydroxyanisol, sorbitol, xylitol, ethylene diamine, piperidine, piperazine, hexamethylene diamine, triazine, triazole, pyrrole, any derivative thereof, and any combination thereof.

12. The adhesive of claim 1, wherein the plasticizer comprises a nonionic surfactant.

13. An article comprising the adhesive of claim 1 disposed on a substrate.

14. The article of claim 13, wherein the adhesive is a pressure sensitive adhesive, the substrate comprises paper, and the article is repositionable.

15. The article of claim 13, wherein the adhesive is a pressure sensitive adhesive, the substrate comprises paper, and the article is not repositionable.

16. The article of claim 13, wherein the adhesive is a hot melt pressure sensitive adhesive and the substrate comprises paper, and wherein the substrate is adhered to a glass surface or a polymer surface.

17. The article of claim 13, wherein the substrate comprises cellulose diacetate.

18. An adhesive comprising:
a base polymer composition that consists of a highly plasticized cellulose ester comprising a cellulose ester and a plasticizer at about 15% or greater by weight of the highly plasticized cellulose ester; and
at least one selected from the group consisting of a tackifying resin, a wax, and any combination thereof.

19. An method comprising:
blending a highly plasticized cellulose ester and an additional polymer, the highly plasticized cellulose ester at about 1% to about 99% by weight of the blend, the additional polymer at about 1% to about 99% by weight of the blend, the highly plasticized cellulose ester comprising a cellulose ester and a plasticizer at about 15% or greater by weight of the highly plasticized cellulose ester, and the additional polymer being selected from the group consisting of a polyolefin, a polyalphaolefin, a polyester, an ethylene vinyl acetate copolymer, a polyvinyl acetate, a polyvinyl alcohol, a polyethyleneimine, a polyacrylate, a polymethacrylate, a polyacrylamide, a polyacrylonitrile, a polyimide, a polyamide, polyvinyl chloride, a polysiloxane, a polyurethane, polystyrene, a polyetheramide copolymer, a styrene-butadiene copolymer, a styrene-butadiene-styrene copolymer, a styrene-isoprene-styrene copolymer, a styrene-ethylene-butylene-styrene copolymer, a styrene-ethylene-propylene-styrene copolymer, butyl rubber, polyisobutylene, a isobutylene-isoprene copolymer, an acrylic, a nitrile, and a combination thereof.

20. The method of claim 19, wherein the blending involves high-shear mixing.
